(19) United States
(12) Patent Application Publication
(10) Pub. No.: US 2013/0329464 A1
(43) Pub. Date: Dec. 12, 2013

(54) DIGITAL POWER CONTROL CIRCUIT FOR POWER CONVERTER AND CONTROL CIRCUIT FOR POWER CONVERTER

(71) Applicants: Ta-Yung Yang, Milpitas, CA (US); Pei-Sheng Tsu, New Taipei City (TW); Yi-Min Hsu, Taichung City (TW); Chung-Hui Yeh, New Taipei City (TW)

(72) Inventors: Ta-Yung Yang, Milpitas, CA (US); Pei-Sheng Tsu, New Taipei City (TW); Yi-Min Hsu, Taichung City (TW); Chung-Hui Yeh, New Taipei City (TW)

(73) Assignee: SYSTEM GENERAL CORP., New Taipei City (TW)

(21) Appl. No.: 13/900,561

(22) Filed: May 23, 2013

Related U.S. Application Data
(60) Provisional application No. 61/656,108, filed on Jun. 6, 2012.

(51) Int. Cl. H02M 3/335

(52) U.S. Cl. CPC H02M 3/33515
USPC 363/21.02

(57) ABSTRACT

A control circuit for a power converter and a digital power control circuit for a power converter are provided. The control circuit comprises a microcontroller, an oscillation circuit, an analog-to-digital converter and a signal generator. The microcontroller comprises a flash memory. The oscillation circuit comprises a phase lock loop for generating a clock signal. The analog-to-digital converter generates a digital feedback signal for the microcontroller corresponding to an output of the power converter. The signal generator is configured to receive the clock signal and data of the microcontroller for generating a switching signal. The switching signal is configured to switch a transformer for regulating the output of the power converter corresponding to the output of the microcontroller.

### CROSS-REFERENCE TO RELATED APPLICATION

This application claims the priority benefit of U.S. provisional application Ser. No. 61/656,108, filed on Jun. 6, 2012. The entirety of the above-mentioned patent application is hereby incorporated by reference herein and made a part of this specification.

### BACKGROUND OF THE INVENTION

1. Field of the Invention

The present invention relates to a power converter, and particularly relates to a digital control circuit with embedded microcontroller for a power converter.

2. Background of the Invention

A power converter is an electrical or electro-mechanical device for converting electrical energy from one form to another, i.e., converting between AC and DC, or just changing the voltage or frequency, or some combination of these. The power converter could be as simple as a transformer to change the voltage of AC power, but also includes far more complex systems. Nowadays, the power converter are required for microcontrollers to achieve less energy losses, a better performance and complete protections.

### SUMMARY OF THE INVENTION

The present invention provides a control circuit for a power converter. The control circuit comprises a microcontroller, an oscillation circuit, an analog-to-digital converter and a signal generator. The microcontroller comprises a flash memory. The oscillation circuit comprises a phase lock loop for generating a clock signal. The analog-to-digital converter is coupled to an output of the power converter and generates a digital feedback signal for the microcontroller. The signal generator is configured to receive the clock signal and a data of the microcontroller for generating a switching signal. The microcontroller controls the switching signal, and the switching signal is configured to switch a transformer for regulating the output of the power converter.

From another point of view, the present invention further provides a digital power control circuit for a power converter. The digital power control circuit comprises a microcontroller, an oscillation circuit, a signal detection circuit and a signal generator. The microcontroller includes a flash memory. The oscillation circuit includes a phase lock loop for generating a clock signal. The signal detection circuit is coupled to an output of the power converter, and is configured to generate a feedback signal. The signal generator is configured to receive the clock signal and the feedback signal for generating a switching signal. The microcontroller controls the switching signal, and the switching signal is configured to switch a transformer for regulating the output of the power converter.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 shows a schematic view illustrating one embodiment of a power converter according to the present invention.

FIG. 2A shows waveforms of the switching signals OA and OB according to the present invention.

FIG. 2B shows waveforms of the switching signals OA, OB and signals DET1, PWM1 according to the present invention.

FIG. 3 shows a block diagram illustrating one embodiment of a controller according to the present invention.

FIG. 4 shows a block diagram illustrating one embodiment of a signal generator according to the present invention.

FIG. 5 shows a circuit diagram illustrating one embodiment of a PWM circuit according to the present invention.

FIG. 6 shows a circuit diagram illustrating one embodiment of a PWM signal generator according to the present invention.

FIG. 7 shows a circuit diagram illustrating one embodiment of a protection circuit according to the present invention.

FIG. 8 shows a circuit diagram illustrating one embodiment of a signal detection circuit according to the present invention.

FIG. 9 shows waveforms of the switching signals OA, OB and switching current I_{P} according to the present invention.

FIG. 10 shows a block diagram illustrating one embodiment of an oscillation circuit according to the present invention.

FIG. 11 shows a circuit diagram illustrating one embodiment of a reference signal generator according to the present invention.

### DETAILED DESCRIPTION OF EMBODIMENTS

The present invention of described embodiments below provides a digital control circuit with embedded microcontroller for a power converter. The digital control circuit reduces the loading of a microcontroller and provides a real time operation to achieve a better performance and complete protections.

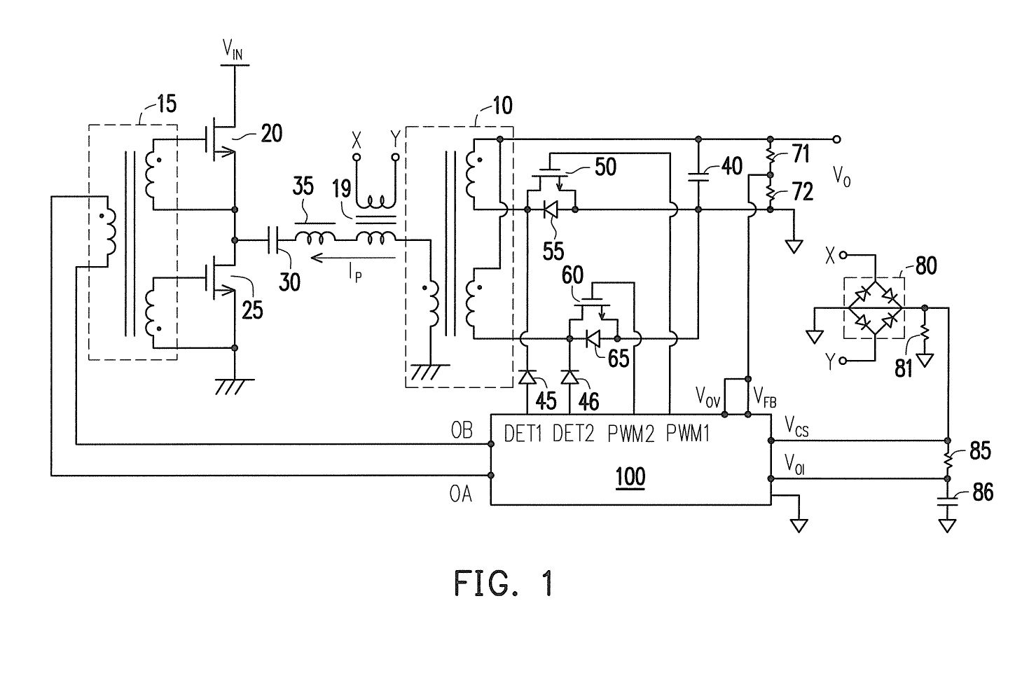

FIG. 1 shows a schematic view illustrating one embodiment of a power converter according to the present invention. Transistors 20 and 25 switch a transformer 10 through a capacitor 30 and an inductor 35. In FIG. 1, the drain of the transistor 20 receives an input voltage V_{IN}. The capacitor 30 and the inductor 35 develop a resonant tank. The inductor 35 may represent as a part of the transformer 10, such as leakage inductance of the transformer 10. The secondary windings of the transformer 10 generate the output voltage V_{O} at a capacitor 40 via rectifiers 55 and 65. Transistors 50 and 60 are connected to the rectifier 55 and 65 respectively for the synchronous rectifying. The rectifiers 55 and 65 may be the body diode of the transistors 50 and 60 respectively. According to the output voltage V_{O}, resistors 71 and 72 form a voltage divider for generating a feedback signal V_{FB} coupled to a controller 100. In accordance with the feedback signal V_{FB}, the controller 100 generated switching signals OA, OB coupled to control the transistors 20, 25 through a driver transformer 15. The frequency of the switching signals OA, OB will determine an output power of the resonant power converter.

A diode 45 is connected to the rectifier 55 for generating a signal DET1 coupled the controller 100. A diode 46 is connected to the rectifier 65 for generating a signal DET2 coupled the controller 100. When the transistor 50 is off, a pulled-low state of the signal DET1 indicates that the rectifier 55 is still turned on. According to the state of the switching signals OA, OB and/or the signals DET1, DET2, the controller 100 generates signals PWM1 and PWM2 to control the synchronous rectifying transistors 50 and 60 respectively.

A current transformer 19 coupled to the transformer 10 detects a switching current Iₚ of the transformer 10 and generates a current signal V_{CS} via a high speed bridge-rectifier 80 and a resistor 81 through signals X and Y. Through a resistor 85 and a capacitor 86, a current signal VOI is further generated in accordance with the current signal V_{CS} for the over-current protection. The current signals V_{CS} and V_{OI} are coupled to the controller 100. A signal V_{OV} is further coupled to the controller 100 for the over-voltage protection. The level of the signal V_{OV} is correlated to the level of the output voltage V_{O}.

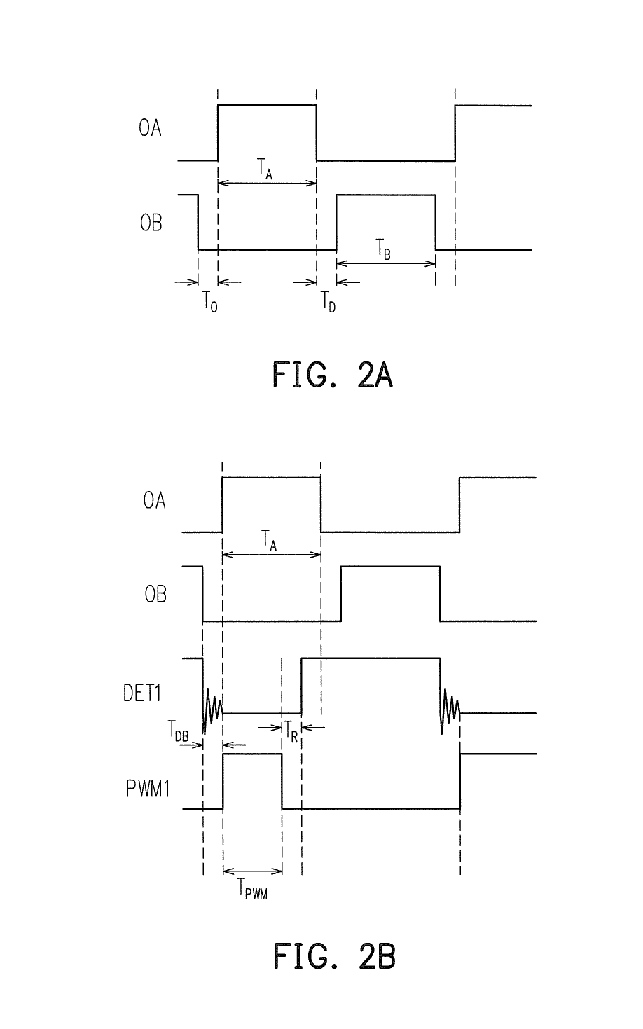

FIG. 2A shows waveforms of the switching signals OA and OB according to the present invention. The on-time period of the switching signal OA is represented as T_{A}. The on-time period of the switching signal OB is represented as T_{B}. T_{D} is the dead-time period in between the switching signals OA and OB. The frequency, the duty-cycle and the pulse width of the switching signals O_{A} and O_{B} may be programmable through timers.

FIG. 2B shows waveforms of the switching signals OA, OB and signals DET1, PWM1 according to the present invention. When the switching signal OA is “pulled-high and/or the signal DET1 is “pulled-low”, then the signal PWM1 will be generated to turn on the transistor 50 for the synchronous rectifying. The T_{DB} is a de-bounce time period provided to assure that the signal DET has been pulled low. The pulse width T_{PWM} of the signal PWM1 is programmable by a timer. Another timer will record the timing T_{R} that starts from “the turn-off of the signal PWM1” to “the pulled-high of the signal DET1”. It means the timing T_{R} records the period from “the turn-off of the transistor 50” to “the turn-off of the rectifier 55”. The timing T_{R} is utilized to program the pulse width T_{PWM} for optimizing the synchronous rectifying.

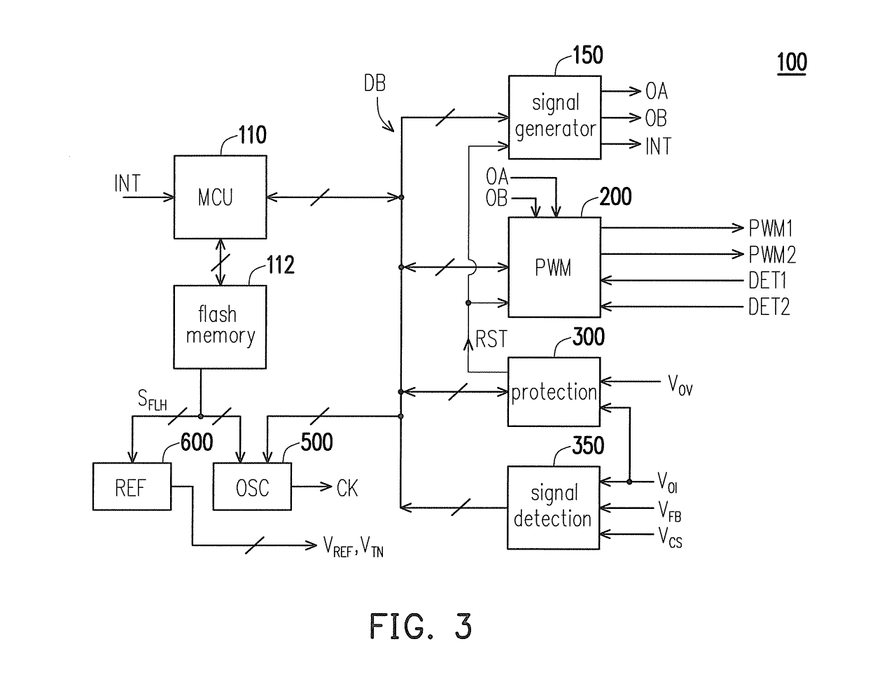

FIG. 3 shows a block diagram illustrating one embodiment of the controller 100 according to the present invention. The controller 100 includes a microcontroller (MCU) 110 having a flash memory 112. The flash memory 112 includes a program memory, a data memory and a calibration memory. An oscillation circuit (OSC) 500 generates a clock signal CK. A reference signal generator (REF) 600 generates reference signals such as V_{REF}, V_{TN}, etc. The calibration memory of the flash memory 112 is configured to calibrate the outputs of the oscillation circuit 500 and the reference signal generator 600. After the power on, the data S_{FLH} of calibration memory of the flash memory 112 will be stored into the oscillation circuit 500 and the reference signal generator 600. For instance, the controller 100 is an IC (integration circuit). The calibration memory is programmed into the flash memory 112 during the mass production of the controller 100.

Through the data bus DB, the microcontroller 110 controls a signal generator 150 to generate the switching signals OA, OB and an interrupt signal INT. The interrupt signal INT is configured to interrupt the microcontroller 110 in response to the falling edge of the switching signals OA, OB. A PWM circuit 200 is coupled to generate the signals PWM1, PWM2 in response to the switching signals OA, OB and/or the signals DET1, DET2. The pulse width of the signals PWM1, PWM2 is programmable by the microcontroller 110. A protection circuit (PROTECTION) 300 generates a reset signal RST configured to turn-off the switching signals OA, OB and signals PWM1, PWM2 when the signal V_{OV} is over a threshold, the signal VOI is over another threshold or a watchdog timer is overflow. A signal detection circuit (SIGNAL DETECTION) 350 is configured to convert the feedback signal V_{FB}, the current signals V_{CS} and V_{OI} to the digital data for the microcontroller 110.

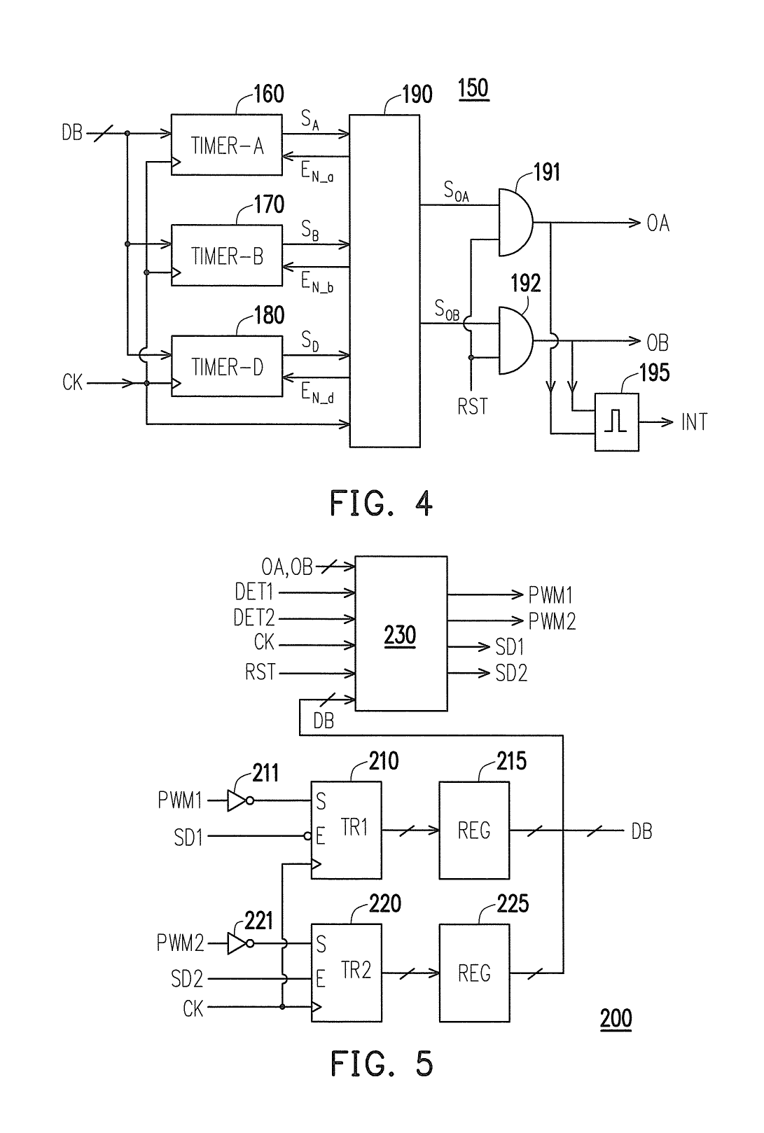

FIG. 4 shows a block diagram illustrating one embodiment of a signal generator 150 according to the present invention. The signal generator 150 includes a timer-A 160 for determining the period of on-time T_{A} of the switching signal OA (shown in FIG. 2A), a timer-B 170 for determining the period of on-time T_{B} of the switching signal OB, and a timer-D 180 for determining the period of dead-time T_{D}. For instance, the timer-A 160 and the timer-B 170 are 16-bit length, and the timer-A 160 and timer-B 170 can be programmed through the data bus DB. The timer-D 180 is 8-bit length, and the timer-D 180 also can be programmed through the data bus DB. The outputs of the timer-A 160, the timer-B 170 and the timer-D 180 are coupled to a logic circuit 190 to generate the switching signals OA, OB via AND gates 191 and 192 by signals S_{A}, S_{B}, S_{D}, E_{N}_{_{—}}ₐ, E_{N}_{_{—}}_{b} and E_{N}_{_{—}}_{d}. The reset signal RST is also connected to the AND gates 191 and 192. The interrupt signal INT can be generated through a pulse generation circuit 195 corresponding to falling edges of the switching signal OA and OB.

FIG. 5 shows a circuit diagram illustrating one embodiment of a PWM circuit 200 according to the present invention. The PWM circuit 200 includes a PWM signal generator 230 for generating the signals PWM1 and PWM2 in response to the switching signals OA, OB and/or signals DET1, DET2. The PWM signal generator 230 also generates trigger signals SD1, SD2. The trigger signals SD1, SD2 are correlated to the signals DET1, DET2. The timer (TR1) 210 receives the signals PWM1 through inverter 211, and the timer (TR2) 220 receives the signals PWM2 through inverter 221. The timer 210 is configured to record the time period T_{R} (shown in FIG. 2B) that begins from turning off of the signal PWM1 to the logic-low state of the trigger signal SD1 corresponding to the rising edge of the signal DET1. A timer 220 is configured to record the period (timing) T_{R} (shown in FIG. 2B) that begins from turning off of the signal PWM2 to the logic-low state of the trigger signal SD2 corresponding to the rising edge of the signal DET2. The data of the timers 210 and 220 are stored in registers (REG) 215, 225 respectively. The microcontroller 110 may read the data of timers 210 and 220 (registers 215, 225) from the data bus DB.

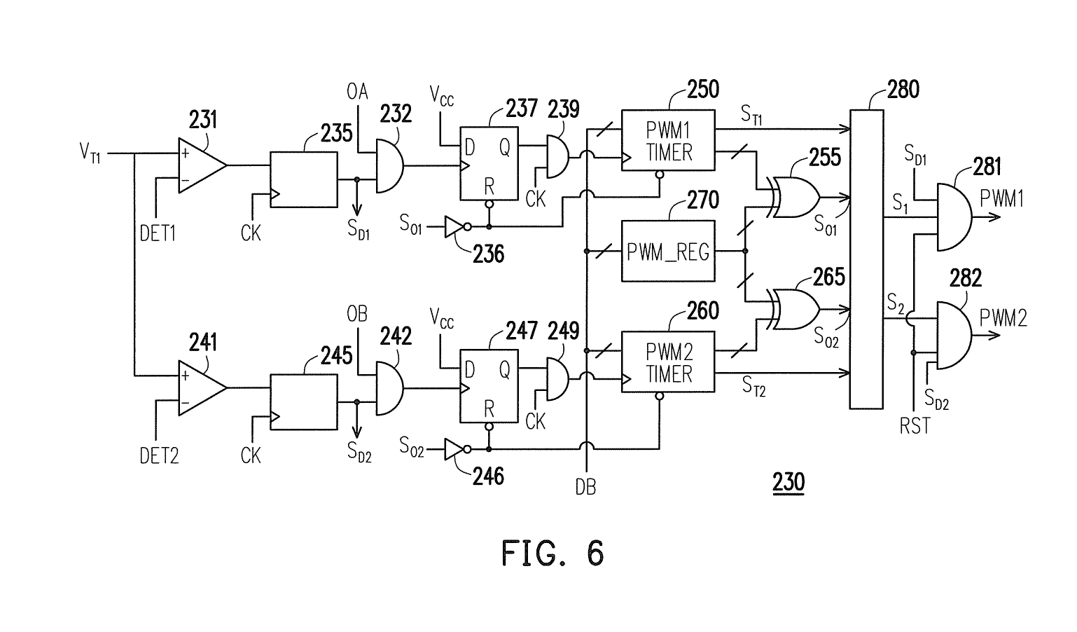

FIG. 6 shows a circuit diagram illustrating one embodiment of a PWM signal generator 230 according to the present invention. The PWM signal generator 230 includes a comparator 231 coupled to receive the signal DET1. The comparator 231 will generate an output signal coupled to a de-bounce circuit 235 according to the comparison result of when the signal DET1 is higher or lower than a threshold V_{T1}. The de-bounce circuit 235 will output a trigger signal S_{D1}. The trigger signal S_{D1} and the switching signal OA are coupled to a flip-flop 237 via an AND gate 232. Through an AND gate 239, the output of the flip-flop 237 is applied to control an input signal for a PWM1 timer 250. The value of the PWM1 timer 250 is programmable by the microcontroller 110 through the data bus DB.

A comparator 241 is coupled to receive the signal DET2. The comparator 241 will generate an output signal coupled to a de-bounce circuit 245 according to the comparison result of when the signal DET2 is higher or lower than the threshold V_{T1}. The de-bounce circuit 245 will output a trigger signal S_{D2}. The trigger signal S_{D2} and the switching signal OB are coupled to a flip-flop 247 via an AND gate 222. Through an AND gate 249, the output of the flip-flop 247 is applied to control an input signal for a PWM2 timer 260. The value of the PWM2 timer 260 is programmable by the microcontroller 110 through the data bus DB.

The data of a register (PWM_REG) 270 is programmable by the microcontroller 110 via the data bus DB. When the clock signal CK is enabled for clocking the PWM1 timer 250, a start signal S_{T1} will be generated. A digital comparator 255 will be configured to compare the value of the PWM1 timer 250 and the value of register 270. When the value of the timer 250 and the value of register 270 are equal, the digital comparator 255 will generate a stop signal S_{O1}. The stop signal S_{O1} is configured to reset the flip-flop 237 and stops the clock signal CK sent into the PWM1 timer 250. Both the start signal S_{T1} and the stop signal S_{O1} are configured to generate the signal PWM1 through a signal S₂, a logic circuit 280 and an AND gate 281.

When the clock signal CK is enabled for clocking the PWM2 timer 260, a start signal S_{T2} will be generated. A digital comparator 265 will be configured to compare the value of the PWM2 timer 260 and the value of register 270. When the value of the PWM2 timer 260 and the value of register 270 are equal, the digital comparator 265 will generate a stop signal S_{O2}. The stop signal S_{O2} is configured to reset the flip-flop 247 and stop the clock signal CK coupled to the PWM2 timer 260. Both the start signal S_{T2} and the stop signal S_{O2} are configured to generate the signal PWM2 through signal S₁, the logic circuit 280 and an AND gate 282. The reset signal RST is coupled to AND gates 281 and 282 to turn off the signals PWM1 and PWM2 when the reset signal RST is enabled for the protection.

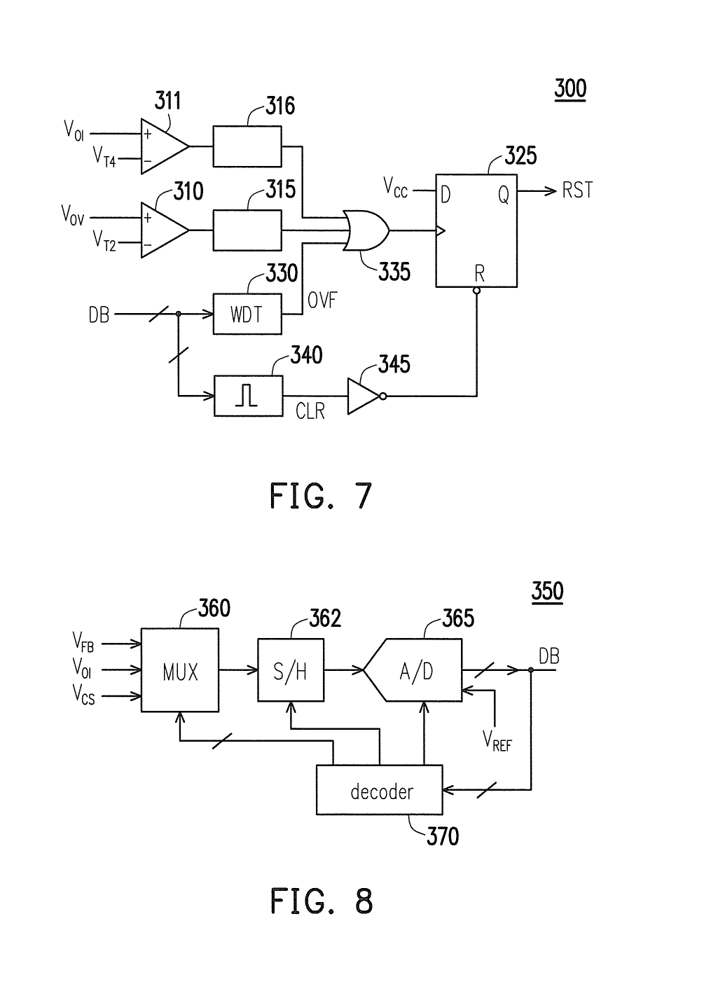

FIG. 7 shows a circuit diagram illustrating one embodiment of a protection circuit 300 according to the present invention. A comparator 310 is configured to receive the signal V_{OV}, and the comparator 310 generates an output signal to a de-bounce circuit 315 when the signal V_{OV} is over a threshold V_{T2}. A comparator 311 is configured to receive the signal V_{OI}, and generate an output signal to a de-bounce circuit 316 when the signal V_{OI} is over a threshold V_{T4}. The output of the de-bounce circuits 315, 316 are coupled to a flip-flop 325 via an OR gate 335 for generating the reset signal RST. Another input of the OR gate 335 is an overflow signal OVF. A watchdog timer (WDT) 330 generates the overflow signal OVF. The watchdog timer 330 is controlled by the microcontroller 110 though the data bus DB. When the protection is happened by the signal V_{OV}, V_{OI} or the watchdog timer 330, the protection state and the reset signal RST will be latched by the flip-flop 325. Only the microcontroller 110 can clear the flip-flop 325 via the data bus DB, a decoder 340 and an inverter 345.

FIG. 8 shows a circuit diagram illustrating one embodiment of a signal detection circuit 350 according to the present invention. A decoder 370 coupled to the data bus DB generates the signals to control a multiplexer (MUX) 360, a sample-and-hold circuit (S/H) 362 and an analog-to-digital converter (A/D) 365. The maximum value of the analog-to-digital converter 365 is scaled by the reference signal V_{REF}. The microcontroller 110 of FIG. 3 can read the output of the analog-to-digital converter 365 through the data bus DB. The multiplexer 360 is configured to receive the feedback signal V_{FB}, the current signals V_{OI} and V_{CS}. Therefore, the microcontroller 110 can read the information of the feedback signal V_{FB} (the feedback data), the current signals V_{OI} and V_{CS}.

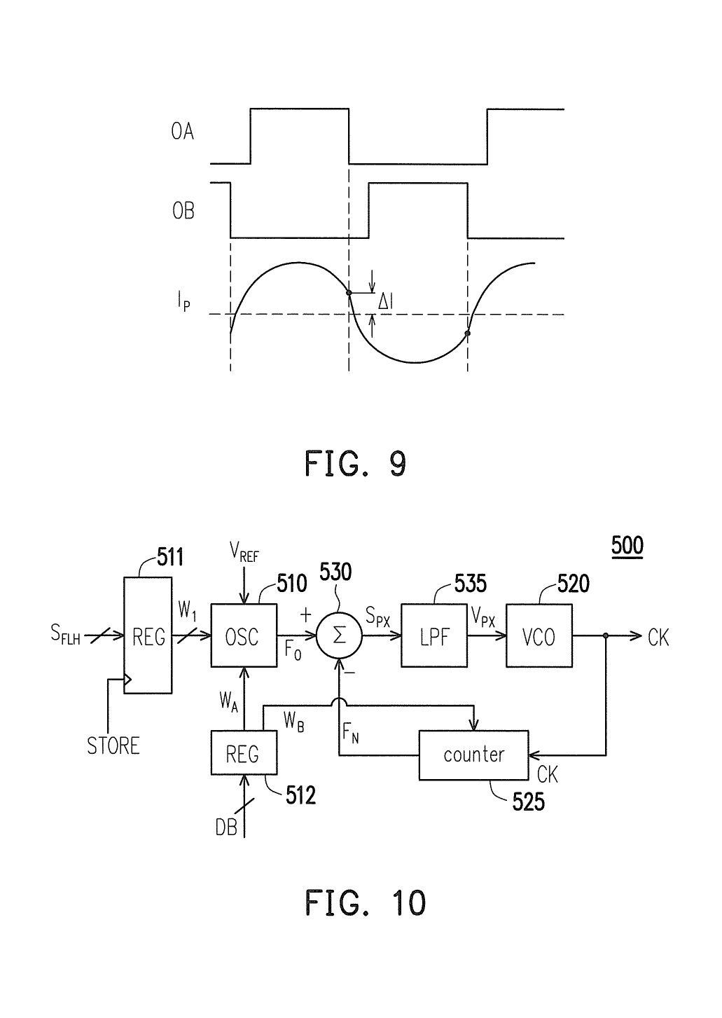

FIG. 9 shows waveforms of the switching signals OA, OB and switching current I_{P} according to the present invention. Refer to FIG. 1 and FIG. 9, the switching current I_{P} is the current flows through the transformer 10 and the current transformer 19 of FIG. 1. The switching current I_{P} can be converted to the signal V_{CS}. By measuring the current signal V_{CS} (through the signal detection circuit 350) in response to the interrupt signal INT (the falling edge of the switching signals OA, OB), the microcontroller 110 can detect the signal level of ΔI. The signal level of ΔI indicates the margin of the switching current IP before it falls to zero current. The level of ΔI is utilized to ensure the switching of the transistors 20 and 30 achieving ZVS (zero voltage switching). It also can make sure the resonant switching can be operated in inductive-mode. The level of ΔI also indicates the lowest switching frequency that is allowed for controlling the resonant power converter.

FIG. 10 shows a block diagram illustrating one embodiment of an oscillation circuit 500 according to the present invention. The oscillation circuit 500 includes an oscillator (OSC) 510 generating an oscillation signal F₀. The frequency of the oscillation signal F₀ is determined by the reference signal V_{REF}, a trim-data signal W₁ and a frequency selection signal W_{A}. A register (REG) 511 is utilized to store the trim-data signal W₁ by signal STORE. The trim-data signal W₁ is loaded from the data S_{FLH} of calibration memory when the power is turned on. A register 512 is utilized to store the frequency selection signals W_{A} and W_{B}. The frequency selection signals W_{A} and W_{B} are loaded from the data bus DB of microcontroller 110. The oscillation signal F₀ is further connected to a phase comparator 530 to compare with a divided-clock signal F_{N}. An error signal S_{PX} generated by the phase comparator 530 is coupled to a voltage-control-oscillator (VCO) 520 through a low-pass filter (LPF) 535. The voltage-control-oscillator (VCO) 520 generates the clock signal CK. The clock signal CK is further coupled to a counter 525 for generating the divided-clock signal F_{N}. The voltage-control-oscillator 520, the counter 525, the phase comparator 530 and the low-pass filter 535 develop a phase lock loop (PLL) for generating the clock signal CK in accordance with the oscillation signal F₀. The frequency of the clock signal is programmable by the trim-data signal W₁ and the frequency selection signals W_{A}, W_{B}.

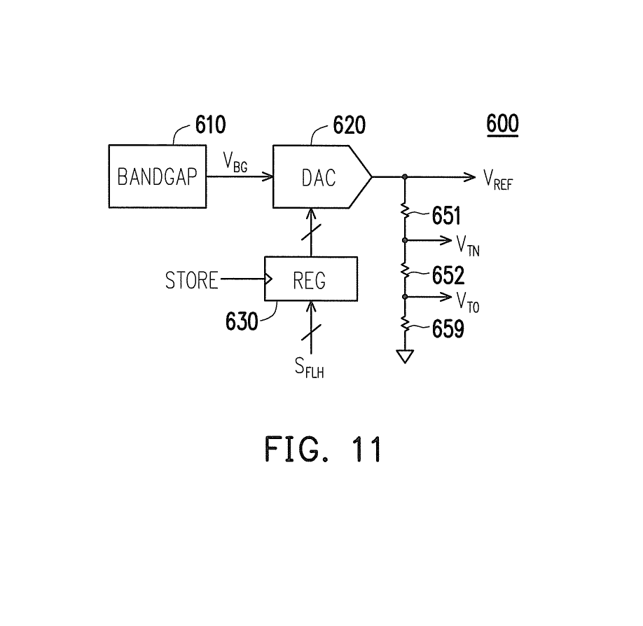

FIG. 11 shows a circuit diagram illustrating one embodiment of a reference signal generator 600 according to the present invention. The reference signal generator 600 includes a bandgap 610 generating a bandgap voltage V_{BG}. The bandgap voltage V_{BG} is operated as a full scale voltage of a digital-to-analog converter (DAC) 620. The digital-to-analog converter 620 generates the reference signal V_{REF} and the threshold signals V_{TN}. V_{T0} in accordance with the bandgap voltage V_{BG} and the data of a register (REG) 630. The data of the register 630 is loaded from the data S_{FLH} of calibration memory when the power is turned on. Therefore, the reference signal V_{REF} and the threshold signals V_{TN} . . . V_{T0} can be precisely produced.

Although the present invention and the advantages thereof have been described in detail, it should be understood that various changes, substitutions, and alternations can be made therein without departing from the spirit and scope of the invention as defined by the appended claims. That is, the discussion included in this invention is intended to serve as a basic description. It should be understood that the specific discussion may not explicitly describe all embodiments possible; many alternatives are implicit. The generic nature of the invention may not fully explained and may not explicitly show that how each feature or element can actually be representative of a broader function or of a great variety of alternative or equivalent elements. Again, these are implicitly included in this disclosure. Neither the description nor the terminology is intended to limit the scope of the claims.

What is claimed is:

1. A control circuit for a power converter, comprising:
a microcontroller having a flash memory;
an oscillation circuit having a phase lock loop for generating a clock signal;
an analog-to-digital converter coupled to an output of the power converter for generating a digital feedback signal for the microcontroller; and
a signal generator configured to receive the clock signal and a data of the microcontroller for generating a switching signal,
wherein the microcontroller controls the switching signal, the switching signal is configured to switch a transformer for regulating the output of the power converter.

2. The control circuit as claimed in claim 1, in which the flash memory is coupled to the oscillation circuit for adjusting a frequency of the clock signal.

3. The control circuit as claimed in claim 1, further comprising a reference signal generator generating a reference signal for the analog-to-digital converter, in which the flash memory is coupled to the reference signal generator for adjusting the reference signal.

4. The control circuit as claimed in claim 1, in which a pulse width of the switching signal is further controlled by the microcontroller for regulating the output of the power converter.

5. The control circuit as claimed in claim 1, further comprising a PWM circuit for generating a PWM signal configured to control a SR transistor for the synchronous rectifying; the PWM circuit is controlled by the microcontroller.

6. The control circuit as claimed in claim 1, further comprising a sense circuit coupled to an output rectifier for detecting an on/off state of the output rectifier and generating a detect signal;
wherein the output rectifier is a rectifier or a body diode of a SR transistor; and the detect signal is configured to turn on the PWM signal.

7. The control circuit as claimed in claim 1, further comprising a current protection circuit configured to detect the switching current of the transformer and turn off the switching signal when the switching current is over an over-current threshold.

8. The control circuit as claimed in claim 1, further comprising a voltage protection circuit configured to detect the output voltage of the power converter and turn off the switching signal when the output voltage is over an over-voltage threshold.

9. A digital power control circuit for a power converter, comprising:
a microcontroller having a flash memory;
an oscillation circuit having a phase lock loop for generating a clock signal;
a signal detection circuit coupled to an output of the power converter for generating a feedback signal; and
a signal generator configured to receive the clock signal and the feedback signal for generating a switching signal,
wherein the microcontroller controls the switching signal, the switching signal is configured to switch a transformer for regulating the output of the power converter.

10. The digital power control circuit as claimed in claim 9, in which the flash memory is coupled to the oscillation circuit for adjusting the frequency of the clock signal.

11. The digital power control circuit as claimed in claim 9, further comprising a reference signal generator generating a reference signal for the signal detection circuit, in which the flash memory is coupled to the reference signal generator for adjusting the reference signal.

12. The digital power control circuit as claimed in claim 9, in which a pulse width of the switching signal is further controlled by the microcontroller for regulating the output of the power converter.

13. The digital power control circuit as claimed in claim 9, further comprising a PWM circuit for generating a PWM signal configured to control a SR transistor for the synchronous rectifying; the PWM circuit is controlled by the microcontroller.

14. The digital power control circuit as claimed in claim 1, further comprising a current protection circuit configured to detect the switching current of the transformer and turn off the switching signal when the switching current is over an over-current threshold.

15. The digital power control circuit as claimed in claim 1, further comprising a voltage protection circuit configured to detect the output voltage of the power converter and turn off the switching signal when the output voltage is over an over-voltage threshold.
